(19) United States
(12) Patent Application Publication
(10) Pub. No.: US 2005/0039081 A1
(43) Pub. Date: Feb. 17, 2005

(54) Method of backing up BIOS settings

(76) Inventors: Wei-Han Chang, Taipei (TW); Wei-Wen Tseng, Taipei (TW)

Correspondence Address: RABIN & BERDO, P.C., Suite 500, 1101 14th Street, N.W., Washington, DC, 20005, US

(21) Appl. No.: 10/665,293

(22) Filed: Sep. 22, 2003

(30) Foreign Application Priority Data
May 20, 2003 (TW) 92113657

(51) Int. Cl. G06F 11/00

(52) U.S. Cl. 714/36; 714/47

(57) ABSTRACT

A method of backing up BIOS settings stored in a CMOS memory of a computer system in DMI memory. In this method, the DMI memory in the flash memory backs up the BIOS settings data stored in the CMOS memory on the motherboard. The BIOS settings stored in the DMI memory can be restored to the CMOS memory to update the BIOS settings for the computer system when the BIOS settings stored in the CMOS memory are lost.

### BACKGROUND OF THE INVENTION

1. Field of the Invention

The present invention relates to a backup method and in particular to a method of backing up BIOS settings in a DMI memory. For example, when BIOS settings are lost, the predetermined BIOS settings stored in the DMI memory block can be restored to the CMOS memory, thereby avoiding computer malfunction.

2. Description of the Related Art

Typically, computer BIOS settings, which include the date, time, models and number of disk drives, number of memories and the like, are stored in a CMOS memory. Generally, the CMOS memory can be integrated into a chipset IC, such as the south bridge chipset IC.

When a computer system is powered on, the computer system executes a power on self test (POST) procedure so as to determine whether the basic peripherals can operate normally. Typically, the POST procedure is the first program executed after the computer system is powered on. The BIOS (basic input/output system) is stored in a flash memory on the motherboard, and has many basic subprograms for the input and output of the computer system, and for processing the motherboard settings and communication for the software and hardware. The BIOS settings relate to the hardware of the computer system. It is possible, for example that the computer system cannot start if the BIOS settings are arbitrarily changed. The BIOS sets and controls the operation of the CPU and the related chips, and controls timing pulses and settings of various standard peripheral devices, such as printers, mouse, keyboard, and various storage mediums. When the BIOS starts the computer system, it determines whether all of the peripheral devices are prepared to operate, if so, the BIOS loads the operating system from the hard disk or floppy disk into the dynamic random access memory (DRAM). BIOS allows the operating system and applications to obtain detailed data about input/output devices, such as the medium access control (MAC) address, the capacity and position of the disk drive, and the like. BIOS settings can be modified to inform the operating system or the application when the peripheral devices are changed.

Typically, a user of a computer system can set the BIOS settings of the computer system. Conventionally, the basic input output system (BIOS) and settings thereof is stored in a CMOS memory of a motherboard of a computer system. Default BIOS settings can be set by the manufacturer or user modified BIOS settings can be stored in the CMOS memory, but may be lost when a computer is unexpectedly powered off, is intentionally powered off, or due to other miss-operations. User modified BIOS settings are stored in the CMOS memory to be read during the power on self test (POST) when the computer is rebooted.

The content of the BIOS is critical due to the BIOS settings saved the basic settings of the entire computer system. If BIOS settings are lost, the entire computer system is endangered. The conventional method of storing the BIOS settings in a flash memory for backup so that BIOS settings can be recovered when lost.

FIG. 1 is a flowchart showing a conventional method of backing up BIOS settings. This method is disclosed in Taiwan patent No. 134407. In step 101, the computer system executes a power on a self test (POST) procedure at startup. Step 102 determines whether the BIOS settings stored in the CMOS memory are present. If the BIOS settings are present, POST procedure is completed in step 106 and the computer then operates normally.

In step 103, the predetermined BIOS settings must be restored the BIOS settings have been lost. The computer system then determines whether flag enabling is loaded, wherein flag enabling is a one-bit signal. An enabling signal is required access predetermined settings stored in the flash memory. In step 104, if flag enabling is loaded, user modified BIOS settings stored in the flash memory are restored to the CMOS memory of the BIOS. In step 105, if flag enabling is not loaded the computer system loads the default settings and stores said settings in CMOS memory. In step 106, regardless of whether default settings or the user modified BIOS settings are loaded, the computer system completes POST procedure, and the present CMOS settings can be restored in flash memory in the subsequent step 107. Thus, if BIOS settings are lost, the backup settings can be used to complete POST procedure. In step 108, the computer system subsequently accomplishes all power on procedures.

The original settings, however, cannot be recovered when the battery maintaining the CMOS memory is damaged or the CMOS memory has errors. Therefore, the user must enter the BIOS menu to reconfigure the BIOS settings. This may be problematic to modify download mechanism as flash memory units are made by different manufacturers and have different specifications.

In order to resolve the previously mentioned problems, the present invention provides a method of backing up the BIOS settings to a block of DMI memory.

### SUMMARY OF THE INVENTION

The present invention relates to a method for backing up BIOS settings and restoring BIOS settings to the CMOS memory in the event of failure with BIOS settings stored in DMI memory. The present invention employs the DMI memory located in a flash memory of the computer system to back up BIOS settings stored in the CMOS memory on the motherboard.

The backup method of the present invention is described in the following. A power on self test procedure is executed when the computer is powered on. The BIOS settings stored in the CMOS memory are detected. If the BIOS settings are lost or the computer system cannot be started up for other reasons, the predetermined settings stored in the DMI memory are written into the CMOS memory and the computer system is rebooted.

### BRIEF DESCRIPTION OF THE DRAWINGS

The present invention can be more fully understood by the subsequent detailed description and examples with reference made to the accompanying drawings, wherein:

FIG. 1 is a flowchart showing a conventional backup method;

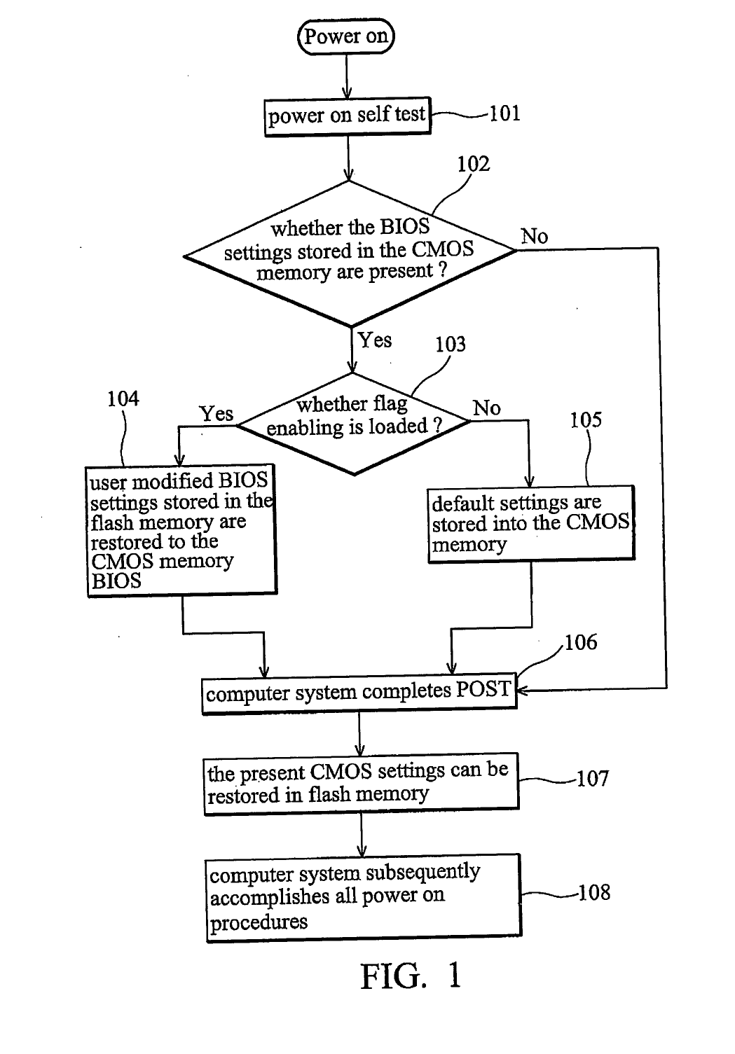

FIG. 2 is a diagram of computer system showing the backup method of the present invention;

FIG. 3 is a flowchart of a method for backing up the BIOS settings in a block of DMI memory according to the present invention; and

FIG. 4 is a flowchart showing the backup method of the BIOS according to the present invention.

### DETAILED DESCRIPTION OF THE INVENTION

Computer systems may execute a power on self test (POST) procedure at start up. The BIOS (basic input/output system) contains settings for the CPU and each of the chips and of various standard peripheral devices. The BIOS settings can be modified after computer system is operational. If BIOS settings are lost due to errors or a damaged battery, however, the BIOS must be reconfigured. This is particularly problematic for large-scale computer systems as it affects the entire system. Therefore, the present invention employs one block of the flash memory on the motherboard, the so called, desktop management interface (DMI) memory, to store a backup of the BIOS settings stored in CMOS memory. The DMI memory is a unified management standard designed to resolve the complexity and conflict of various software and hardware specifications. Therefore, the DMI memory is the same in different systems and does not change even if the memory specification is varied. Additionally, the DMI memory can be located in the flash memory, it is to be understood that the invention is not limited to the disclosed embodiments. In the present invention, this DMI memory block is used to back up the CMOS memory and is suitable for various specifications without modifying the accessing program thereof.

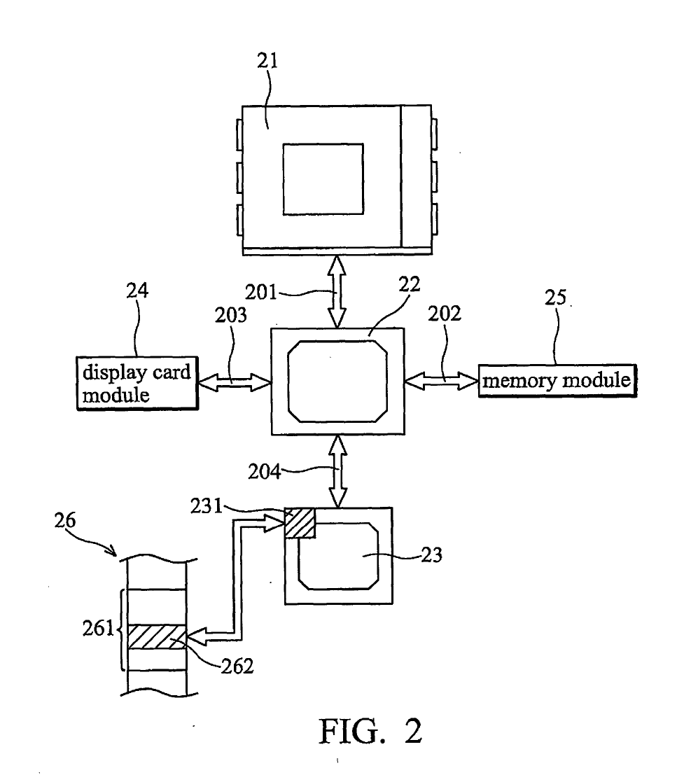

FIG. 2 is a diagram of computer system showing the backup method of the present invention. In the computer system, all devices are connected to the CPU 21 via bus so as to communicate with the CPU 21. The bus connects the CPU 21 and the peripheral devices on the motherboard of the computer so as to transmit data between the CPU 21 and the peripheral devices. As shown in FIG. 2, the central processing unit (CPU) 21 processes and calculates the data for the whole computer system, and is connected to the north bridge chip 22 via a front side system bus (FSB) 201. Conventionally, the north bridge chip 22 is connected to the memory module 25 by the double data rate (DDR) memory bus 202, and is connected to the display card module 24 via an accelerated graphic port (AGP) bus 203 for data transmission. The AGP bus 203 is a type of slot on the motherboard, and transmits image data between the CPU and the AGP display card. The north bridge chip 22 is connected to the south bridge chip 23 via a peripheral component interconnect (PCI) bus 204. The south bridge chip 23 is a control chip to connect and control the peripheral devices which can be extension interfaces, such as sound cards, network cards, and input devices. The peripheral devices may also be disk controllers to connect to storage devices, such as hard disk drives, floppy disk drives and the like.

The BIOS settings are stored in the CMOS memory (231), and the CMOS memory (231) is generally located in the south bridge chip 23. The BIOS controls the connections and operations between the CPU and each of the chips, and detects the connection between the standard peripheral devices. In the present invention, the DMI memory 261 in the flash memory 26 on the motherboard backs up and accesses data stored in the CMOS memory 231. Namely, the BIOS is backed up in the memory block 262 assigned by the DMI memory 261. When data stored in the CMOS memory 231 is lost due to errors or other reasons, the backup BIOS can be restored to the CMOS memory 231.

When data loss in CMOS memory 231 is detected by the computer system, the computer system automatically loads BIOS settings stored in the memory block 262 of the DMI memory 261, thus restoring user modified or factory default BIOS settings to the CMOS memory 231. In order to employ the DMI memory 261 to access and back up the data (BIOS and BIOS settings) stored in the CMOS memory 231, the DMI memory 261 must be modified from read-only to writable to enable storage of the desired backup data. In the present invention, a corresponding memory block in the DMI memory is used to store predetermined BIOS settings as backup. Accordingly, the BIOS settings in the CMOS memory can be updated according to the backup BIOS settings stored in the corresponding memory block of the DMI memory.

The backup method of the present invention is described in detail in the following.

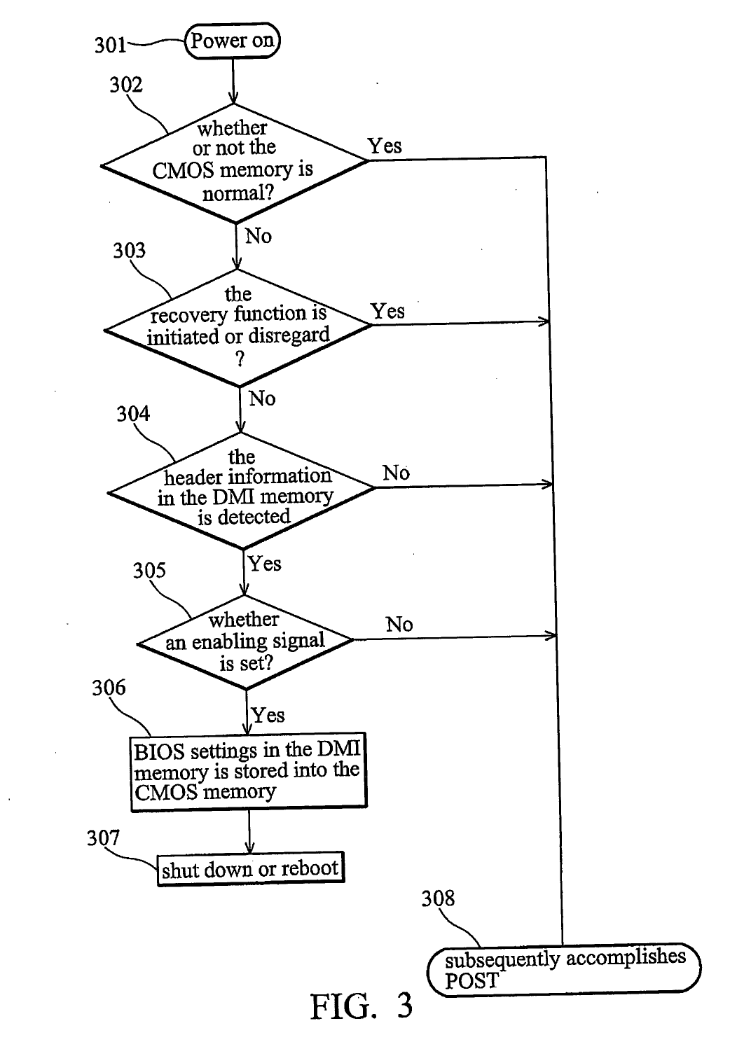

FIG. 3 is a flowchart showing a method for backing up BIOS settings of a CMOS memory in a computer system by a DMI memory block according to the embodiment of the present invention. In step 301, when the computer system is powered on, the computer system executes POST procedure including BIOS detection for peripherals. Step 302 determines whether or not the CMOS memory is normal. POST procedure is completed in step 308 if the CMOS memory is normal and the BIOS settings are correct. The computer system then issues a query to determine whether the BIOS settings should be written to CMOS memory from the DMI memory (recovery function) if the CMOS memory is erroneous or damaged. The BIOS settings stored in DMI memory can be the default settings provided by the manufacturer, or previous user modified BIOS settings. In step 303, a user can initiate or disregard the recovery function. If the recovery function is not initiated POST is completed in the subsequent step 308. Next, if the recovery function is initiated, the computer system detects the header information stored in the DMI memory in step 304, wherein the header information defines the data type of the DMI memory. The computer system subsequently completes POST procedure (step 308) even if the system cannot be started due to the absence of data in the DMI memory, namely, no backup data for the CMOS memory is stored in the DMI memory. In step 305, the computer system detects and determines whether an enabling signal is set if the header information shows that backup data for the CMOS memory is stored in the DMI memory.

Typically, when the computer system requires a memory block, an address decoder may transmit an enable signal to enable writing to the memory block. As shown in FIG. 3, the computer system detects whether the enabling signal is set in step 305.

The computer system does not write the stored data (BIOS settings) to the CMOS memory from the DMI memory, and then subsequently accomplishes POST procedure in step 308, if it is determined that the enabling signal is not set, and the computer system does not transmit an enabling signal to enable the writing function of the DMI memory. On the contrary, the stored data (BIOS settings) in the DMI memory may be stored into the CMOS memory in step 306 if the enable signal is set. Next, the computer system is shut down or rebooted to complete POST procedure with the backup BIOS settings provided by DMI memory in step 307.

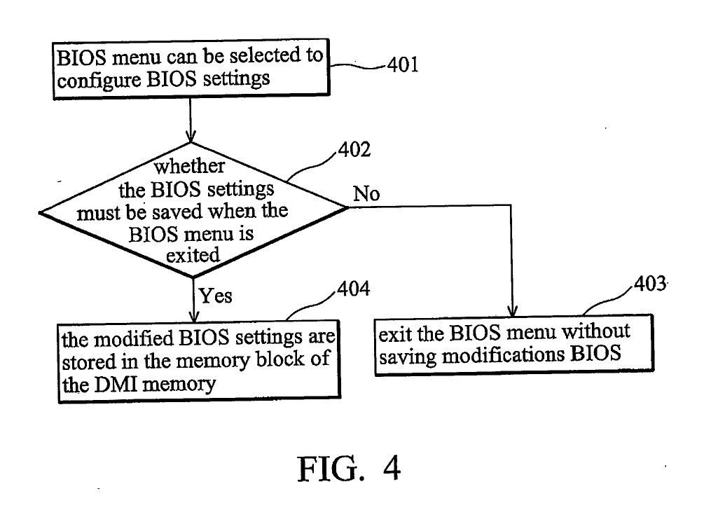

FIG. 4 is a flowchart of backing up BIOS settings to a DMI memory according to the method of the present invention. The computer system executes a power on self test (POST) procedure when the computer system is powered on. The computer system may display a prompt to enter the BIOS menu. The prompt can be ignored and the computer system subsequently completes the POST procedure as determined by a user. Alternately, the BIOS menu can be selected to configure BIOS settings in step 401. BIOS settings contain computer and peripheral data such as memory and CPU operating frequencies, detection settings for the floppy and hard disk drives, communication ports, and the like. In step 402, after the BIOS settings are configured, the computer system detects whether the BIOS settings must be saved when the BIOS menu is exited. In step 403, the computer system may exit the BIOS menu without saving modifications BIOS if the user chooses to exit the BIOS menu without saving. In step 404, if the BIOS setting menu is exited and changes are saved, the modified BIOS settings are stored in the memory block of the DMI memory.

In the present invention, the BIOS settings stored in CMOS memory can be backed up in DMI memory. In the method of the present invention, the BIOS settings are stored in a DMI memory block in a flash memory. The backup data (BIOS settings or BIOS) stored in the DMI memory can be restored to the CMOS if the BIOS stored in CMOS memory is abnormal.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A method of backing up BIOS settings stored in a CMOS memory in a computer system by a DMI memory, the method comprising steps of:
executing a power on self test (POST) procedure after powering on the computer system;
detecting BIOS settings stored in the CMOS memory; and
writing predetermined BIOS settings stored in the DMI memory into the CMOS memory if the BIOS settings stored in the CMOS memory are abnormal.

2. The method of claim 1, wherein the computer system subsequently accomplishes the POST procedure if the BIOS settings stored in the CMOS memory are normal.

3. The method of claim 1, wherein the BIOS settings are backed up in a memory block of the DMI memory.

4. The method of claim 1, wherein the DMI memory is located in a flash memory.

5. A method of backing up BIOS settings stored in a CMOS memory in a computer system by a DMI memory, the method comprising the steps of:
executing a power on self test (POST) procedure after powering on the computer system;
detecting whether the BIOS settings stored in the CMOS memory are normal;
determining whether to ignore a reloading function;
detecting header data of the DMI memory;
determine whether to access the DMI memory according to whether an enabling signal has been set; and
writing predetermined BIOS settings stored in the DMI memory into the CMOS memory.

6. The method of claim 5, wherein the computer system subsequently accomplishes the POST procedure if the BIOS settings stored in the CMOS memory are normal.

7. The method of claim 5, wherein the computer system subsequently accomplishes the POST procedure if the reloading function is ignored.

8. The method of claim 5, wherein the computer system subsequently accomplishes the POST procedure if the DMI memory has no header information.

9. The method of claim 5, wherein the computer system subsequently accomplishes the POST procedure if the enabling signal is not set.

10. The method of claim 5, wherein the BIOS settings are backed up in a memory block of a DMI memory.

11. The method of claim 5, wherein the DMI memory is located in a flash memory.

12. A method of backing up BIOS settings stored in a CMOS memory in a computer system into a DMI memory, comprising:
entering a BIOS setting menu;
querying whether BIOS settings being save after exiting the BIOS setting menu;
backing up the BIOS settings into the DMI memory.

13. The method of claim 12, wherein the BIOS settings are stored in a memory block of the DMI memory.

14. The method of claim 12, wherein the DMI memory is located in a flash memory.

15. The method of claim 12, wherein the BIOS settings are not saved if saving BIOS settings after exiting the BIOS settings menu is not required.

16. A method of backing up a BIOS setting stored in the CMOS memory of a computer system by a DMI memory, the DMI memory including a memory block for storing predetermined BIOS settings in the computer system, the method comprising the following steps:
storing the predetermined BIOS settings stored in the CMOS memory to the memory block of the DMI memory;
updating the BIOS settings stored in the CMOS memory according to the predetermined BIOS setting stored in the memory block of the DMI memory.

17. The method of claim 16, wherein the corresponding memory block of the DMI memory is located in a flash memory.

18. The method of claim 16, wherein the CMOS memory is located in a south bridge chipset.

19. A computer system for backing up BIOS settings in a memory block of a flash memory, comprising:
a central processing unit (CPU);
a front side system bus (FSB) for connecting a north bridge chip to the CPU;
a double data rate (DDR) memory bus for connecting the north bridge chip to a memory module;
an accelerated graphic port (AGP) bus for connecting the north bridge chip to a display card module;
a peripheral component interconnect (PCI) bus for connecting a south bridge chip to a plurality of peripheral devices;
a CMOS memory located in the south bridge chip; and
a flash memory located on a motherboard of the computer system, wherein the flash memory comprises a first memory block for a DMI memory.

20. The computer system of claim 19, wherein the BIOS settings are stored in the CMOS memory.

21. The computer system of claim 19, wherein the memory block of the flash memory comprises a memory block for the DMI memory, and the DMI memory backs up the BIOS settings.
